(19) United States
(12) Patent Application Publication
(10) Pub. No.: US 2026/0297257 A1
(43) Pub. Date: Oct. 1, 2026

(54) CYCLIC POLY(HYDROXY-URETHANE) FOAMS IN WALL AND ROOFING INSULATION

(71) Applicant: JOHNS MANVILLE, Denver, CO (US)

(72) Inventors: Bret Boyle, Littleton, CO (US); Lance Wang, Parker, CO (US); Jawed Asrar, Englewood, CO (US)

(21) Appl. No.: 19/097,364

(22) Filed: Apr. 1, 2025

(51) Int. Cl. C08G 71/04; B32B 5/02; B32B 5/18; B32B 5/24; B32B 29/02; C08J 9/06; C08J 9/14; C08K 5/00; E04B 1/80

(52) U.S. Cl. CPC C08G 71/04; B32B 5/02; B32B 5/18; B32B 5/245; B32B 29/02; C08J 9/06; C08J 9/141; C08J 9/146; C08K 5/0066; E04B 1/80; B32B 2266/0278; B32B 2307/3065; B32B 2419/06; B32B 2607/00; C08G 2110/005; C08G 2110/0083; C08J 2201/022; C08J 2375/04

(57) ABSTRACT

Poly(hydroxy urethane) foam insulation products and methods of their production and use are provided. Poly(hydroxy urethane) foam insulation products can include a poly(hydroxy urethane) polymer having: a cyclic carbonate monomer with two or more cyclic carbonate groups and a substituted or unsubstituted hydrocarbon backbone containing one or more cyclic groups, a multifunctional primary amine, and a multifunctional thiol, for example. The poly(hydroxy urethane) foam insulation product is free of isocyanate groups.

### BACKGROUND

Polyisocyanurate foam (i.e., PIR board stock) has been widely used to insulate roofs and walls of commercial and industrial buildings for many decades due to its excellent thermal insulation, flame resistance, and mechanical properties. Polyisocyanurate foams, also called “polyiso” foams, may be made by combining separate liquid mixtures that include the polyisocyanates (the A-side mixture) and the polyols (the B-side mixture). The A-side mixture and B-side mixture can be combined to form the polyiso foam product. Therefore, existing polyisocyanurate and polyurethane foam products include isocyanate. However, there is currently a desire to reduce or eliminate the use of isocyanate in industrial products, as the precursor to isocyanate, phosgene, as well as isocyanate itself, are difficult to work with due to toxicity concerns.

Thus, while polyisocyanurate foams may provide excellent insulation as compared with some other materials, it would be beneficial to provide an insulation or other foam product that is free of isocyanate. It would also be beneficial to provide a non-isocyanate polyurethane that exhibits the structural and fire retardancy properties of polyiso foam products.

### BRIEF SUMMARY

Embodiments of the present technology may provide urethane-based foams that are free from isocyanates, and that exhibit excellent structural and fire retardancy properties. Some embodiments can involve a roofing or wall system, comprising: an insulation product, the insulation product comprising: a poly(hydroxy urethane) foam formed from components comprising: a cyclic carbonate monomer, wherein the cyclic carbonate monomer comprises two or more cyclic carbonate groups and a substituted or unsubstituted hydrocarbon backbone containing one or more cyclic groups, and a multifunctional amine; and one or more facers affixed to the insulation product; wherein any reactants used to make the insulation product are free of isocyanate groups. In some embodiments, the insulation product comprises a poly(hydroxy urethane) foam board. In some embodiments, the poly(hydroxy urethane) foam board comprises a poly(hydroxy urethane) insulation board. In other embodiments, the poly(hydroxy urethane) foam board comprises a roof board or a cover board. In other embodiments, the poly(hydroxy urethane) foam board comprises a sheathing/wall board. In some embodiments, the insulation product has an R-value per inch of at least 5.7 when measured at 75° F. In some embodiments, the substituted or unsubstituted hydrocarbon backbone comprises two or more cyclic groups, wherein the two or more cyclic groups comprise substituted or unsubstituted aromatic groups. In some embodiments, the poly(hydroxy urethane) foam has a decomposition temperature (Td) of greater than or about 300° C. In some embodiments, the poly(hydroxy urethane) foam has a density of greater than or about 0.4 pounds/ft³. In some embodiments, the poly(hydroxy urethane) foam has a compressive strength of greater than or about 15 psi. In some embodiments, the poly(hydroxy urethane) foam is formed using a blowing agent. In some embodiments, the components used to produce the poly(hydroxy urethane) foam further comprise a multifunctional thiol. In some embodiments, the components used to produce the poly(hydroxy urethane) form further comprise exothermic reactants used to carry out an exothermic reaction for accelerating the formation of the poly(hydroxy urethane) polymer. In some embodiments, the exothermic reaction utilizes a poly(epoxy)-poly(amine) reaction, a poly(epoxy)-poly(thiol) reaction, a Michael addition reaction (using known reactants), a poly(acrylate)-poly(amine) reaction (via Aza-Michael addition), a thiolene reaction (via UV or Thia-Michael addition), a UV-catalyzed acrylic reaction, or a poly(anhydride)-poly(amine) reaction, or any combination thereof. In some embodiments, the exothermic reaction helps blow off the physical blowing agent, the chemical blowing agent, or the combination thereof. In some embodiments, the poly(hydroxy urethane) foam comprises the reaction products of the exothermic reaction. In some embodiments, a physical blowing agent, a chemical blowing agent, or a combination thereof is used to produce the poly(hydroxy urethane) foam. In some embodiments, the facer comprises coated/uncoated fiberglass mat, felt, foil, paper, or any combinations thereof. In some embodiments, the insulation product further comprises a surfactant. In some embodiments, the surfactant comprises Niax Silicone L6900, Tegostab B84506, Vorasurf™, DC 193, or any combination thereof. In some embodiments, the insulation product further comprises a halogenated flame retardant, a non-halogenated flame retardant, or a combination thereof. In some embodiments, the halogenated fire retardant comprises tris(2-chloroisopropyl)phosphate (TCPP) and the non-halogenated fire retardant comprises diethyl hydroxylmethyl phosphonate (DEHMP), butyl diphenyl phosphate, dibutyl phenyl phosphate, triphenyl phosphate, diethyl N,N-bis(2-hydroxyethyl)aminomethylphosphonate (DEHAMP), dialkyl hydroxyalkanephosphonate (e.g., dimethyl hydroxymethylphosphonate), diaryl hydroxyalkanephosphonate (e.g., diphenyl hydroxymethylphosphonate), or any combination thereof.

Some embodiment can involve a method of forming a poly(hydroxy urethane) foam wall or roof insulation product, comprising: providing a cyclic carbonate monomer, wherein the cyclic carbonate monomer comprises two or more cyclic carbonate groups and a substituted or unsubstituted hydrocarbon backbone containing one or more cyclic groups; introducing a multifunctional amine and a blowing agent; and forming a poly(hydroxy urethane) foam; wherein the reactants used to make the poly(hydroxy urethane) foam insulation product are free of isocyanate groups. In some embodiments, the step of providing a cyclic carbonate monomer comprises carbonating one or more epoxides with a hydrocarbon backbone containing one or more cyclic groups. In some embodiments, carbonating comprises using a catalyst and a temperature of greater than or about 60° C. In some embodiments, the forming a poly(hydroxy urethane) foam step comprises combining the cyclic carbonate monomer, multifunctional primary amine, and blowing agent with at least one catalyst. In some embodiments, the substituted or unsubstituted hydrocarbon backbone comprises two or more cyclic groups, wherein the two or more cyclic groups comprise substituted or unsubstituted aromatic groups. In some embodiments, forming poly(hydroxy urethane) foam comprises carrying out an exothermic reaction to accelerate polymerization of the poly(hydroxy urethane) polymer. In some embodiments, the exothermic reaction comprises a poly(epoxy)-poly(amine) reaction, a poly(epoxy)-poly(thiol) reaction, a Michael addition reaction (using known reactants), a poly(acrylate)-poly(amine) reaction (via Aza-Michael addition), a thiolene reaction (via UV or Thia-Michael addition), a UV-catalyzed acrylic reaction, or a poly(anhydride)-poly(amine) reaction, or any combination thereof. In some embodiments, forming poly(hydroxy urethane) foam comprises using an physical blowing agent to produce the foam. In some embodiments, the physical blowing agent comprises a hydrocarbon, a fluorocarbon, or any combination thereof. In some embodiments, the physical blowing agent comprises cyclopentane, isopentane, n-pentane, or any mixture thereof. In some embodiments, the physical blowing agent comprises HFC-245fa, HFC-365mfc, HFC-134a, HCFO 1233zd (Solstice® LBA by Honeywell Corp), Forane® 1233zd, HFO-1336mzz (Chemours Opteon™ 1100), or any combination thereof. In some embodiments, the blowing agent comprises a chemical blowing agent. In some embodiments, the chemical blowing agent comprises a thiol, water, or a combination thereof. In some embodiments, the introducing step further comprises introducing a surfactant. In some embodiments, the introducing step further comprises introducing a halogenated flame retardant, a non-halogenated flame retardant, or a combination thereof.

Some embodiments involve a poly(hydroxy urethane) foam wall or roofing insulation product, comprising: a poly(hydroxy urethane) polymer produced from components comprising: a cyclic carbonate monomer, wherein the cyclic carbonate monomer comprises two or more cyclic carbonate groups and a substituted or unsubstituted hydrocarbon backbone containing one or more cyclic groups; a multifunctional amine; one or more exothermic reactants; and a blowing agent comprising: a multifunctional thiol, a hydrocarbon, a fluorocarbon, or any combination thereof; wherein any components used to produce poly(hydroxy urethane) foam insulation product are free of isocyanate groups.

### BRIEF DESCRIPTION OF THE DRAWINGS

FIG. 1 illustrates a foam board in accordance with embodiments of the present technology.

FIG. 2 illustrates is a method of forming a polyisocyanurate foam board, in accordance with embodiments of the present technology.

FIG. 3 illustrates a wall or roof system or structure in accordance with embodiments of the present technology.

FIG. 4 illustrates a method of forming a wall of a structure in accordance with embodiments of the invention.

FIG. 5 shows a construction of a commercial roof deck in accordance with embodiments of the invention.

FIG. 6 illustrates a method of forming a roofing system in accordance with embodiments of the invention.

### DETAILED DESCRIPTION OF THE INVENTION

Several different characteristics are desirable in polyiso boards used for building insulation or other applications. Of course, a high insulating value is desired, for reducing energy consumption and providing comfort in the building. In addition, the insulation boards should be strong enough to withstand handling and usage without significant damage, including during construction. Furthermore, applications desire for foam products to exhibit excellent fire retardancy to meet modern building standards. It is also desirable that the viscosity of the B-side (e.g., comprising amine and, optionally, thiol) mixture be low, to facilitate processing of the formulation during board manufacturing.

Attempts have been made to form non-isocyanate polyurethanes. Such attempts have utilized long chain aliphatic carbonates in combination with nucleophilic amines to form poly(hydroxy urethane). However, current attempts to form non-isocyanate polyurethanes exhibit poor structural stability and fire retardancy. Namely, due to the flexibility of the aliphatic backbone, existing non-isocyanate polyurethanes fail to provide the rigidity, toughness, temperature stability, and fire retardance necessary for use in building products, such as foams, and are therefore primarily used in elastomeric applications.

The present technology has surprisingly found that by utilizing a cyclic carbonate and a multifunctional amine in accordance with the description herein, poly(hydroxy urethanes) having cyclic functional groups are formed that exhibit excellent structural and fire retardancy properties when used in wall and/or roofing insulation applications. Namely, the present technology has found that by forming poly(hydroxy urethanes) having cyclic functional groups (e.g., aromatic groups) as described herein, foams may be formed that exhibit structural and fire retardancy properties in wall and/or roofing applications similar to existing polyiso foams. Furthermore, due to the unique structure, foams according to the present technology may be crosslinked in the presence of one or more thiols, allowing for the foam to be “self-blown” without the inclusion of external blowing agents.

Unlike polyiso foams, the poly(hydroxy urethanes) of the present technology may utilize one or more cyclic carbonate monomers in the A-side mixture. In some embodiments, the A-side mixture can also contain epoxy. The cyclic carbonate monomers discussed herein may contain one or more cyclic carbonate groups (such as ethylene carbonate, as an example only). However, in embodiments, the cyclic carbonate monomers have two or more cyclic carbonate groups. Namely, by having at least di-functionality, crosslinking in the final foam product may be obtained so as to achieve the structural properties discussed herein. However, in embodiments, mono-functional cyclic carbonate monomers may be blended with higher functionality cyclic carbonate monomers in order to achieve the desired level of crosslinking. Nonetheless, in embodiments, the cyclic carbonate monomer may have two or more cyclic carbonate groups, three or more, four or more, five or more, or combinations thereof, in order to produce a highly crosslinked poly(hydroxy urethane).

Regardless of the number of cyclic carbonate groups, the cyclic carbonate monomers discussed herein contain one or more cyclic groups within the cyclic carbonate monomer backbone. Namely, as discussed above, the present technology has found that by incorporating one or more aromatic groups into the cyclic carbonate monomer backbone and/or by using a multifunctional amine with an aromatic group (e.g., aromatic diamine) and/or an multifunction thiol with an aromatic group (e.g., benzene-1,2-dithiol) to produce the poly(hydroxy urethane), improved structural and fire retardancy properties were obtained in the poly(hydroxy urethane) foam. In embodiments, the cyclic carbonate monomer backbone includes one or more substituted or unsubstituted C₆-C₂₄ hydrocarbon groups. However, as discussed above, the hydrocarbon group contains one or more cyclic fragments, such as two or more, three or more, four or more, five or more, or combinations thereof. Thus, the cyclic carbonate monomers discussed herein contain one or more substituted or unsubstituted cyclic rings within the hydrocarbon backbone. In embodiments, the one or more substituted or unsubstituted cyclic rings may be aromatic, or may be a five membered ring, as examples only. The hydrocarbon group and/or the one or more cyclic rings within the hydrocarbon chain may be further substituted with heteroatoms, including N, S, O, and combinations thereof.

For instance, in embodiments, the cyclic carbonate monomer may be obtained from the carbonation of the epoxy group(s) of one or more epoxy compounds having a cyclic ring within the hydrocarbon backbone. Thus, in embodiments, the cyclic carbonate monomers discussed herein may be obtained from renewable sources. For instance, suitable epoxy compounds may be obtained from the epoxidation of one or more polyols having a substituted or unsubstituted hydrocarbon backbone with one or more substituted or unsubstituted cyclic groups, such as bisphenol-A, bisphenol-F, a diglycidyl ether of resorcinol, xylene alcohol, vanillyl alcohol, 2, 5, furandimethanol, a phenol/triazine arylhydroxy-aldehyde condensate resin, or combinations thereof, as examples only. Namely, as discussed above, it should be clear that other cyclic epoxy compounds are contemplated herein as starting materials for the cyclic carbonate monomer, such as cyclic epoxy compounds having mono-cyclic, di-cyclic, tri-cyclic, or greater backbones, as well as one or more, two or more, three of more, four or more, five or more, or greater epoxy groups.

In such embodiments, the carbonation may occur in the presence of one or more catalysts at elevated temperatures. The catalyst may be a suitable carbonation catalyst, for example, amine catalysts (e.g., triethanolamine, DMAP), quaternary ammonium salts (e.g., tetrabutylammonium bromide, TBAI), metal organic frameworks (MOFs) with acidic and basic sites, metal-based catalysts (e.g., alkali metal and alkali earth metal base catalysts, boron and carbon base catalysts, transition metal), organic catalysts (e.g., ammonium, phosphonate, imidazolium, amide-based catalysts, and carbenyl catalysts), N-heterocyclic carbenes (NHCs), Ionic Liquids (IL), or any combinations thereof. In some embodiments, the catalyst is tetra-n-butylammonium iodide. In some embodiments, the catalyst is a species that activates the epoxide and allows a nucleophile to attack the carbon ring to open the epoxide and allow insertion of the CO₂. In embodiments, temperatures greater than or about 60° C. may be utilized for the carbonation, such as greater than or about 65° C., greater than or about 70° C., greater than or about 75° C., greater than or about 80° C., or any ranges or values therebetween. In terms of ranges, in some embodiments, the temperatures for the carbonation can be from 20° C. to 120° C., e.g., from 23° C. to 120° C. or from 23° C. to 100° C.

In embodiments, the A-side mixture may account for about 40 wt. % of the poly(hydroxy urethane) foam to about 60 wt. % of the poly(hydroxy urethane) foam, such as greater than or about 42.5% wt. %, such as greater than or about 45 wt. %, such as greater than or about 47.5 wt. %, such as greater than or about 50 wt. %, such as greater than or about 52.5 wt. %, such as greater than or about 55 wt. %, such as greater than or about 57.5 wt. %, or such as less than or about 60 wt. %, such as less than or about 57.5 wt. %, less than or about 55 wt. %, less than or about 52.5 wt. %, or any ranges or values therebetween.

However, in embodiments, the stoichiometric ratios of the A-side to the B-side may be approximately 1:1, such as from about 0.9:1 to 1.2:1, such as from about 1:1 to 1.15:1, such as from about 1:1 to 1.1:1 or any ranges or values therebetween. Namely, in embodiments, it may be desired to have a small excess of the A-side in order to prevent any unreacted nucleophile. However, in embodiments, an approximate 1:1 ratio may be utilized.

Nonetheless, in embodiments, the A-side mixture may only contain the cyclic carbonate monomers discussed herein or may contain one or more additional components.

In some embodiments, the mixture can also contain at least one additional component that undergoes an exothermic reaction. The exothermic reaction can release enough energy to accelerate the poly(cyclic carbonate) and polyamine primary reaction discussed. Thus, the exothermic reaction can begin at ambient temperature, for example. Various reactant(s) can be utilized depending on reaction kinetics and/or processing timescales. For example, in some embodiments a poly(epoxy)-poly(amine) reaction, a poly(epoxy)-poly(thiol) reaction, a Michael addition reaction (using known reactants), a poly(acrylate)-poly(amine) reaction (via Aza-Michael addition), a thiolene reaction (via UV or Thia-Michael addition), a UV-catalyzed acrylic reaction, or a poly(anhydride)-poly(amine) reaction, or any combination thereof can be utilized as an exothermic reaction. Thus, in some embodiments the A-side mixture can additionally contain at least one epoxy resin, an acrylic resin, Michael acceptor, and/or a cyclic carbonate, or any combination thereof to produce an initial exothermic reaction to accelerate the primary reaction, for example. Similarly, in some embodiments, the B-side mixture can additionally contain at least one thiol, amine, and/or water, or combinations thereof to produce an initial exothermic reaction to accelerate the primary reaction, for example. Any of the examples of A-side components for exothermic acceleration might be utilized with any of the examples of B-side components, as long as the combinations produce an exothermic reaction sufficient to accelerate the primary reaction. These examples are not limiting, other reactants able to produce an exothermic reaction sufficient to accelerate the primary reaction can be used. In addition, in some embodiments, the exothermic reaction can help to blow off the blowing agent (physical, chemical, or combinations thereof).

The B-side mixture of the poly(hydroxy urethane) foam may include one or more multifunctional nucleophilic monomers, prepolymers, or oligomers, for example. In embodiments, the nucleophilic monomer may include one or more primary amines. In embodiments, the primary amine may be a di- or tri-functional amine, or may contain greater functionality. The di- or tri-functional primary amine may include an aliphatic or aromatic hydrocarbon backbone between the amine functionality, which may be substituted or unsubstituted, and which may contain one or more cyclic groups. In some embodiments, the hydrocarbon backbone can have a length from 2 to 30 carbon atoms, e.g., from 2 to 20 carbon atoms, from 2 to 15 carbon atoms, from 2 to 10 carbon atoms, or from 2 to 6 carbon atoms. In some embodiments, the hydrocarbon backbone has no branching. In embodiments, the hydrocarbon backbone may be substituted with one or more heteroatoms, including N, S, O, and combinations thereof. By utilizing such multi-functional nucleophiles, crosslinking with the cyclic carbonate monomer may be achieved so as to provide poly(hydroxy urethane) foams having excellent structural and fire retardancy properties. However, in embodiments, it should be clear that the nucleophilic monomer may be a mono-functional nucleophile, such as in embodiments where a blend of nucleophilic monomers may be utilized, so as to include a mixture of lower functionality and higher functionality nucleophilic monomers.

Example multifunctional primary amines may include aliphatic and aromatic polyamines, such as ethylene diamine, toluene diamines such as a combination of 3,5-diethyltoluene-2,4-diamine and 3,5-diethyltoluene-2,6-diamine sold under the tradename Ethacure® 100 by Albemarle Corp, m-Xylene Diamine, isophorone diamine, tris (2-aminoethyl)amine (TREN), Diethylenetriamine (DETA), melamine resins, and/or polyetheramines such as Jeffamine® T-403 and D-230 sold by Huntsman Corporation, among others.

In embodiments, the one or more nucleophilic monomers, such as the primary amine, may form greater than or about 25 wt. % of the B-side mixture, such as greater than or about 30 wt. %, greater than or about 35 wt. %, greater than or about 40 wt. %, greater than or about 45 wt. %, greater than or about 50 wt. %, greater than or about 55 wt. %, greater than or about 60 wt. %, greater than or about 65 wt. %, greater than or about 70 wt. %, greater than or about 75 wt. %, greater than or about 80 wt. %, greater than or about 85 wt. %, greater than or about 90 wt. %, greater than or about 95 wt. %, greater than or about 97.5 wt. %, greater than or about 99 wt. %, up to about 100 wt. %, or such as less than or about 99 wt. %, less than or about 97.5 wt. %, less than or about 95 wt. %, less than or about 90 wt. %, less than or about 85 wt. %, less than or about 80 wt. %, less than or about 75 wt. %, less than or about 70 wt. %, less than or about 65 wt. %, less than or about 60 wt. %, less than or about 55 wt. %, less than or about 50 wt. %, less than or about 45 wt. %, less than or about 40 wt. %, less than or about 35 wt. %, less than or about 30 wt. %, or any ranges or values therebetween.

Regardless of the nucleophile utilized, the primary amine may be present in an amount of from about 25 wt. % of the poly(hydroxy urethane) foam to about 60 wt. % of the poly(hydroxy urethane) foam, such as greater than or about 27.5 wt. %, such as greater than or about 30 wt. %, such as greater than or about 32.5 wt. %, such as greater than or about 35 wt. %, such as greater than or about 37.5 wt. %, such as greater than or about 40 wt. %, such as greater than or about 42.5 wt. %, such as greater than or about 45 wt. %, such as greater than or about 47.5 wt. %, such as greater than or about 50 wt. %, or such as less than or about 60 wt. %, such as less than or about 55 wt. %, less than or about 50 wt. %, less than or about 45 wt. %, or any ranges or values therebetween.

In embodiments, the B-side mixture may also include one or more multifunctional thiols. The multifunctional thiol may include di-functionality, tri-functionality, or greater. Namely, the present technology has surprisingly found that by utilizing one or more multi-functional thiols in the B-side mixture, the one or more multi-functional thiols may contribute to crosslinking with the cyclic carbonate monomer during foam formation and may also release CO₂ during crosslinking. Thus, the one or more multifunctional thiols may reduce or eliminate the need for external blowing agents, and may therefore characterize the foam as “self-blown.” In embodiments, multifunctional thiols may include an aliphatic or aromatic hydrocarbon backbone between the amine functionality, which may be substituted or unsubstituted, and which may contain one or more cyclic groups (e.g., benzen-1,2-dithiol). In some embodiments, the hydrocarbon backbone can have a length from 2 to 30 carbon atoms, e.g., from 2 to 20 carbon atoms, from 2 to 15 carbon atoms, from 2 to 10 carbon atoms, or from 2 to 6 carbon atoms. In some embodiments, the hydrocarbon backbone has no branching. In embodiments, the hydrocarbon backbone may be substituted with one or more heteroatoms, including N, S, O, and combinations thereof (e.g., 2,2′-(ethylenedioxy)diethanethiol). In such a manner, the multi-functional thiol may contribute to the crosslinking during formation of the poly(hydroxy urethane) foam to achieve the structural and fire retardancy properties of the insulation products discussed herein, while also providing CO₂ to the foamed compound. However, in embodiments, it should be clear that the multifunctional thiol may be a mono-functional thiol, such as in embodiments where a blend of thiols may be utilized, so as to include a mixture of lower functionality and higher functionality thiols.

In embodiments, when utilized, the one or more multifunctional thiols, may form from about 1 wt. % to about 80 wt. % of the B-side mixture, such as greater than or about 2.5 wt. %, greater than or about 5 wt. %, greater than or about 7.5 wt. %, greater than or about 10 wt. %, greater than or about 12.5 wt. %, greater than or about 15 wt. %, greater than or about 17.5 wt. %, greater than or about 20 wt. %, greater than or about 22.5 wt. %, greater than or about 25 wt. %, greater than or about 27.5 wt. %, greater than or about 30 wt. %, greater than or about 32.5 wt. %, greater than or about 35 wt. %, greater than or about 37.5 wt. %, greater than or about 40 wt. %, greater than or about 50 wt. %, greater than or about 60 wt. %, greater than or about 70 wt. %, greater than or about 75 wt. %, or such as less than or about 80 wt. %, as less than or about 70 wt. %, as less than or about 60 wt. %, as less than or about 50 wt. %, less than or about 45 wt. %, less than or about 40 wt. %, less than or about 35 wt. %, less than or about 30 wt. %, less than or about 25 wt. %, less than or about 20 wt. %, less than or about 15 wt. %, less than or about 10 wt. %, less than or about 5 wt. %, less than or about 1 wt. %, or any ranges or values therebetween.

Nonetheless, it should be clear that, in embodiments, no multifunctional thiol may be utilized, and instead, an external blowing agent may be utilized. For instance, in embodiments, external blowing agents may include hydrocarbon gas (e.g., n-pentane, isopentane, cyclo-pentane, etc.) and/or fluorocarbon gas, among others. The blowing agent may include a mixture of isopentane and n-pentane. Specific examples of fluorocarbon gases may include HFC-245fa (i.e., 1,1,1,3,3-pentafluoropropane) commercially available under the tradename Enovate® from Honeywell Corp., HFC-365mfc (i.e., CF₃CH₂CF₂CH₃), HFC-134a (i.e., 1,1,1,2-tetrafluoroethane), HCFO 1233zd (i.e., trans-1-chloro-3,3,3-trifluoropropene) sold under tradename Solstice® LBA by Honeywell Corp., Forane® 1233zd by Arkema, and HFO-1336mzz (1,1,1,4,4,4-hexafluoro-2-butene) sold under trade name Opteon™ 1100 by Chemours. The blowing agent may be in the B-side mixture, for example. In some embodiments, the blowing agent is a 50/50 mixture of n-pentane and isopentane.

In embodiments, the one or more external blowing agents may be present in an amount of about 1 wt. % to about 10 wt. % based upon the weight of the poly(hydroxy urethane) foam, such as greater than or about 1.5 wt. %, such as greater than or about 2 wt. %, such as greater than or about 2.5 wt. %, such as greater than or about 3 wt. %, such as greater than or about 3.5 wt. %, such as greater than or about 4 wt. %, such as greater than or about 4.5 wt. %, such as greater than or about 5 wt. %, such as greater than or about 5.25 wt. %, such as greater than or about 5.5 wt. %, or such as less than or about 9 wt. %, such as less than or about 8.5 wt. %, such as less than or about 8 wt. %, such as less than or about 7.5 wt. %, such as less than or about 7 wt. %, such as less than or about 6.5 wt. %, such as less than or about 6 wt. %, or any ranges or values therebetween.

In embodiments, an optional catalyst may be used in poly(hydroxy urethane) foam formation. Some examples include aminolysis catalysts such as 1,5,7-triazabicyclo[4.4.0]dec-5-ene (TBD), 1,8-diazabicyclo[5.4.0]undec-7-ene (DBU), organic bases, alkali metal salts, organometallic catalysts, bronsted acids, potassium hydroxide, and/or thiourea-based catalysts. Optional catalysts may include catalysts that catalyze crosslinking between the multifunctional nucleophile, multifunctional thiol (if present) and cyclic carbonate monomer to form the poly(hydroxy urethane) polymer as well as generation or incorporation of CO₂ to form the foamed poly(hydroxy urethane) polymer.

In embodiments, the one or more catalysts may be present in an amount of about 0.1 wt. % to about 5 wt. % based upon the weight of the poly(hydroxy urethane) foam, such as greater than or about 0.2 wt. %, such as greater than or about 0.4 wt. %, such as greater than or about 0.6 wt. %, such as greater than or about 0.8 wt. %, such as greater than or about 1 wt. %, such as greater than or about 1.2 wt. %, such as greater than or about 1.4 wt. %, such as greater than or about 1.6 wt. %, such as greater than or about 1.8 wt. %, such as greater than or about 2 wt. %, such as greater than or about 2.5 wt. %, or such as less than or about 4 wt. %, such as less than or about 3.5 wt. %, such as less than or about 3 wt. %, such as less than or about 2.5 wt. %, such as less than or about 2.25 wt. %, such as less than or about 2 wt. %, such as less than or about 1.9 wt. %, or any ranges or values therebetween.

The poly(hydroxy urethane) foam may also include one or more surfactants. The surfactants function to improve compatibility of the formulation components and stabilize the cell structure during foaming. Example surfactants can include organic or silicone based materials, or non-silicone materials. Example surfactants that may be useful in embodiments of the invention include Niax Silicone L6900 (Momentive), Tegostab B84506 (Evonik Industries), Vorasurf™ sold by The Dow Chemical Company and DC 193 sold by Dow Corning Company.

In embodiments, the one or more surfactants may be present in an amount of about 0.01 wt. % to about 1 wt. % based upon the weight of the poly(hydroxy urethane) foam, such as greater than or about 0.02 wt. %, such as greater than or about 0.04 wt. %, such as greater than or about 0.06 wt. %, such as greater than or about 0.08 wt. %, such as greater than or about 0.1 wt. %, such as greater than or about 0.12 wt. %, such as greater than or about 0.14 wt. %, such as greater than or about 0.16 wt. %, such as greater than or about 0.18 wt. %, such as greater than or about 0.2 wt. %, such as greater than or about 0.22 wt. %, such as greater than or about 0.24 wt. %, such as greater than or about 0.26 wt. %, such as greater than or about 0.28 wt. %, or such as less than or about 0.9 wt. %, such as less than or about 0.8 wt. %, such as less than or about 0.7 wt. %, such as less than or about 0.6 wt. %, such as less than or about 0.5 wt. %, such as less than or about 0.4 wt. %, such as less than or about 0.3 wt. %, or any ranges or values therebetween.

The poly(hydroxy urethane) foam may also include non-halogenated and/or halogenated fire retardants. In some embodiments, the poly(hydroxy urethane) foam may include a halogenated fire retardant such as tris(2-chloroisopropyl)phosphate (TCPP). In some embodiments, the poly(hydroxy urethane) foam may include a non-halogenated fire retardant such as diethyl hydroxylmethyl phosphonate (DEHMP). The non-halogenated fire retardant may reduce the amount of halogenated fire retardants such as TCPP use in the foams. The poly(hydroxy urethane) foam may be able to form a sufficiently stable char when exposed to flame conditions in accordance with ASTM E-84. The stable char enables the poly(hydroxy urethane) foam to pass the ASTM E-84 test. The poly(hydroxy urethane) foam insulation boards may exhibit an ASTM E1354-11 b performance that is equivalent with or better than a similar polyisocyanurate foam insulation board having a traditional halogenated or non-halogenated fire retardant that does not have a foam index discussed herein.

In some embodiments, the non-halogenated fire retardant may include a phosphorus-containing fire retardant such as: an organo-phosphate, an organo-phosphite, and/or an organo-phosphonate. The non-halogenated organo phosphorus fire retardant could be non-reactive or reactive, i.e. containing isocyanate reactive functionality. An example non-reactive organo phosphorus fire retardant is a butyl diphenyl phosphate, dibutyl phenyl phosphate, and triphenyl phosphate, as well as combinations thereof. Example reactive organo phosphorus fire retardants include diethyl hydroxylmethyl phosphonate (DEHMP) and diethyl N,N-bis(2-hydroxyethyl)aminomethylphosphonate (DEHAMP, also known as Fyrol 6) sold by ICL and Lanxess. In other embodiments, the phosphorous containing non-halogenated fire retardant may include: dialkyl hydroxyalkanephosphonate (e.g., dimethyl hydroxymethylphosphonate), diaryl hydroxyalkanephosphonate (e.g., diphenyl hydroxymethylphosphonate), and the like.

Regardless of the fire retardant or retardants selected, the one or more fire retardants may be present in an amount of about 0.1 wt. % to about 5 wt. % based upon the weight of the poly(hydroxy urethane) foam, such as greater than or about 0.2 wt. %, such as greater than or about 0.4 wt. %, such as greater than or about 0.6 wt. %, such as greater than or about 0.8 wt. %, such as greater than or about 1 wt. %, such as greater than or about 1.2 wt. %, such as greater than or about 1.4 wt. %, such as greater than or about 1.6 wt. %, such as greater than or about 1.8 wt. %, such as greater than or about 2 wt. %, such as greater than or about 2.5 wt. %, such as greater than or about 2.7 wt. %, or such as less than or about 4.5 wt. %, such as less than or about 4 wt. %, such as less than or about 3.5 wt. %, such as less than or about 3 wt. %, such as less than or about 2.75 wt. %, such as less than or about 2.5 wt. %, or any ranges or values therebetween. Surprisingly, the poly(hydroxy urethane) foam according to the present technology provide insulation with excellent fire retardancy and strength even at low fire retardant concentrations.

Nonetheless, it should be clear that, in some embodiments, external fire retardants may not be necessary, as the poly(hydroxy urethane) foam exhibits excellent fire retardancy due to the backbone containing significant aromatic components. However, some embodiments can include flame retardant additives.

The B-side mixture may also include an emulsifier.

A polyiso formulation according to the present technology may also have a metallo-organic compound as part of its B-side mixture. For example, a compound of zinc or bismuth with various coordinating organic ligands may be used, and may impart favorable properties to the resulting foam. An example of an additive including a zinc compound and usable in embodiments of the invention is KKAT® XK-614 Zinc complex available from King Industries, Inc. USA. An example of a bismuth additive usable in embodiments of the invention is KKAT®-XC-C227 Bismuth complex, 2-ethylhexanoic acid (CAS 149-57-5) also sold by King Industries, Inc. USA. In some embodiments, the metallo-organic compound may include carbon, and may be for example a zinc salt such as a zinc carboxylate. In some embodiments, the metallo-organic compound may be about 0.1 to 1.0 weight percent of the B-side mixture.

Regardless of the final composition of the A-side and B-side mixtures, a poly(hydroxy urethane) foam may be formed by combining the A-side and B-side mixtures and subjecting the combination to crosslinking and polymerization. For instance, the one or more cyclic carbonate monomers may be combined with the multifunctional nucleophile and the multifunctional thiol or external blowing agent as well as any one or more of the additional components discussed above, and subjected to crosslinking and polymerization in the presence of a catalyst and elevated temperature, yielding the poly(hydroxy urethane) foam. In embodiments, suitable catalysts may include kinetic catalysts, including amine catalysts such as 1,8-diazabicyclo[5.4.0]undec-7-ene (DBU), as an example only. Some additional examples include aminolysis catalysts such as 1,5,7-triazabicyclo[4.4.0]dec-5-ene (TBD), organic bases, alkali metal salts, organometallic catalysts, bronsted acids, potassium hydroxide, and/or thiourea-based catalysts. In embodiments, temperatures greater than or about 80° C. may be utilized for the foam formation, such as greater than or about 85° C., greater than or about 90° C., greater than or about 95° C., greater than or about 100° C., or any ranges or values therebetween. In terms of ranges, temperatures for foam formation can, in some embodiments, be between 25° C. and 200° C., e.g., between 30° C. and 180° C., between 50° C. and 150° C., between 70° C. and 150° C., or between 80° C. and 130° C.

In embodiments, the one or more cyclic carbonate monomers may be introduced in the form of a solid. In such embodiments, the one or more cyclic carbonate monomers may be dissolved in one or more solvents. In embodiments, the one or more solvents may include a polar aprotic solvent, such as tetrahydrofuran, as an example only. Other examples can include carbonate and/or acetone. In some embodiments, the one or more cyclic carbonate monomers are not dissolved in a solvent, for example when fluid monomers and/or heated up pre-polymers are used.

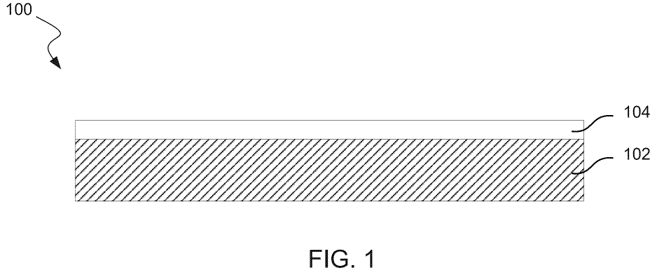

Referring now to FIG. 1, illustrated is an embodiment of a poly(hydroxy urethane) foam board 100 (hereinafter foam board 100). The foam board 100 includes a poly(hydroxy urethane) core 102 that is produced from the cyclic carbonate monomer, multifunctional nucleophile, and multifunctional thiol (when present) as discussed above. The poly(hydroxy urethane) core 102 typically has an average foam cell size of less than about 200 microns, and more commonly between about 100-150. In contrast, conventional foam boards typically have an average foam cell size of between about 200 and 300. The smaller foam cell size of the poly(hydroxy urethane) core 102 may allow the core to exhibit an increased R-value when compared with conventional cores. In some embodiments, a poly(hydroxy urethane) foam preferably has a cell size of less than 120 microns.

The foams formed herein may exhibit a decomposition temperature of greater than or about 250° C., greater than or about 260° C., greater than or about 270° C., greater than or about 280° C., greater than or about 290° C., greater than or about 300° C., greater than or about 310° C., greater than or about 320° C., or any ranges or values therebetween. In some embodiments, the foams described may have a thermal decomposition temperature (Td) of greater than or equal to 300° C.

Thus, the foams may exhibit excellent temperature stability and/or flame resistance.

Moreover, the foams formed herein may exhibit excellent structural stability, such as high compressive strength, such as a compressive strength as measured according to ASTM C1289 and/or ASTM D1621 of greater than or about 15 psi, greater than or about 16 psi, greater than or about 17 psi, greater than or about 18 psi, greater than or about 19 psi, greater than or about 20 psi, or any ranges or values therebetween.

R-values herein are measured according to ASTM standard test method C518, surface burning characteristics are measured according to ASTM standard test method E84 and E1354, as will be discussed in greater detail below.

The foam insulation board may have different core densities. For example, a foam insulation board may have a core density of between about 0.5 and 3 lbs/ft³, including between about 1.0 and 2.5 lbs/ft³, such as between about 1.5 and 2 lbs/ft³, or any ranges or values therebetween. For insulation purposes, a foam insulation board in accordance with embodiments of the invention preferably has a core density of less than 2.0 lbs/ft³, and more preferably less than 1.7 lbs/ft³, and even more preferably less than 1.61 lbs/ft³.

Foam board 100 also includes an optional facer material 104 that is applied to at least one surface of the poly(hydroxy urethane) core 102. The facer material 104 typically includes a glass fiber mat, but may include other types of facer materials. The facer material 104 is typically selected based on the type of polyisocyanurate foam board produced. For example, facers for polyisocyanurate foam insulation boards that are used in roofing applications may include: a reinforced cellulosic felt facer, an un-coated polymer bonded glass fiber mat, a coated polymer bonded glass fiber mat, a fiberglass reinforced paper facer (GRF) and the like. In such embodiments, the facer 104 may include a mineral and/or pigment based coating with high solid content to provide one or more desired characteristics, such as low porosity, fire retardancy, mechanical strength, and the like. The facer 104 may have a thickness of between about 0.3 and 1.2 mm.

Facers for poly(hydroxy urethane) foam cover boards that are used in roofing applications may include: coated polymer bonded glass fiber mat, which provides desired characteristics, such as low porosity, fire retardancy, mechanical strength, and the like. In such embodiments, the facer 104 may have a thickness of between about 0.4 and 1.2 mm Facers for poly(hydroxy urethane) foam boards that are used in wall applications may include a metal foil facer that is configured to reflect heat, such as from and/or into a structure, and/or may include an un-coated polymer bonded glass mat, coated polymer bonded glass mat, a fiberglass reinforced paper facer (GRF) and the like. In such embodiments, the facer 104 may have a thickness of between about 0.006 and 1.2 mm. The thickness of 0.006 mm typically represents the thickness of a metal facer while the 1.2 mm represents the thickness of other facers.

Although FIG. 1 shows the facer 104 being positioned on a single side of the poly(hydroxy urethane) core 102, it should be realized that in many embodiments an additional facer may be positioned on the opposite side of the poly(hydroxy urethane) core 102. The additional facer may be a similar or different facer than facer 104 and/or may have a different thickness and/or material coating as desired.

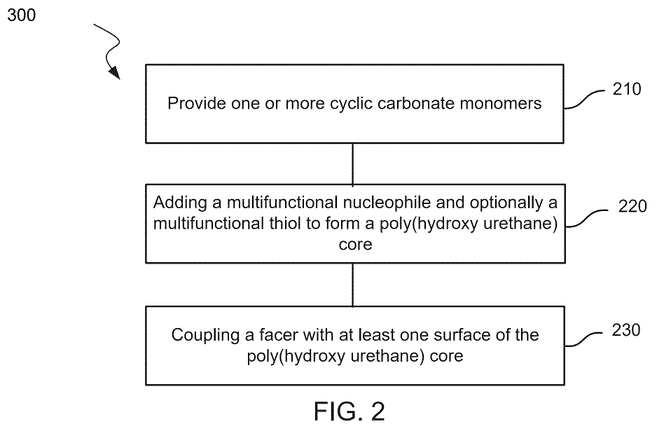

Referring now to FIG. 2, illustrated is a method of forming a poly(hydroxy urethane) foam board. At block 210, one or more cyclic carbonate monomers are provided. At block 220, an a multifunctional nucleophile and optionally a multifunctional thiol is added to the one or more cyclic carbonate monomers to form a poly(hydroxy urethane) core. A fire retardant may be added the poly(hydroxy urethane) core. At block 230, a facer material is coupled with at least one surface of the poly(hydroxy urethane) core. The facer material includes a glass fiber mat, or other mat, that may be selected based on the end application of the poly(hydroxy urethane) foam board as described herein. In some embodiments, an additional facer material may be coupled with an opposite surface of the poly(hydroxy urethane) core.

The resulting poly(hydroxy urethane) core may have an R-value measured at 40° C. of greater than 5.9 R/in, such as greater than or about 6.0 R/in, greater than or about 6.1 R/n, greater than or about 6.2 R/in, greater than or about 6.3 R/in, greater than or about 6.4 R/in, greater than or about 6.5 R/in, greater than or about 6.6 R/in, greater than or about 6.7 R/in, greater than or about 6.8 R/in, greater than or about 6.9 R/in, greater than or about 7 R/in, or any ranges or values therebetween.

Moreover, the resulting poly(hydroxy urethane) core may exhibit an R-value measured at 25° C. of greater than 5.7 R/in, such as greater than or about 5.8 R/in, greater than or about 5.9 R/in, greater than or about 6.0 R/in, greater than or about 6.1 R/in, greater than or about 6.2 R/in, greater than or about 6.3 R/in, greater than or about 6.4 R/in, greater than or about 6.5 R/in, greater than or about 6.6 R/in, greater than or about 6.65 R/in, or any ranges or values therebetween.

The resulting poly(hydroxy urethane) core may exhibit a flame development index (ASTM E84) of less than 35, such as less than or about 34, such as less than or about 33, such as less than or about 32, such as less than or about 31, such as less than or about 30, or any ranges or values therebetween. Additionally or alternatively, in embodiments, the resulting poly(hydroxy urethane) core may exhibit a smoke development index (ASTM E84) of less than 450, such as less than or about 425, such as less than or about 400, such as less than or about 375, such as less than or about 350, such as less than or about 325, such as less than or about 300, such as less than or about 290, such as less than or about 285, such as less than or about 280, such as less than or about 275, such as less than or about 270, such as less than or about 265, such as less than or about 260, such as less than or about 255, such as less than or about 250, or any ranges or values therebetween.

### Example Formulations

An example formulation used to produced foams according to the disclosure is shown in Table 1.

TABLE 1

| Ingredient | Parts | Foam Wt % |
|---|---|---|
| B-Side Formulation | | |
| Trifunctional polyetheramine - | 80.5 | 29.8 |
| Jeffamine T-403 | | |
| 2,2′(ethylenedioxy)diethanethiol | 16.7 | 6.17 |
| 1,8-Diazabicyclo[5.4.0]undec-7- | 2.8 | 1.03 |
| ene | | |
| Total “B” | 100 | 37 |
| A-Side Formulation | | |
| Bisphenol A-Based Cyclic | 100 | 63 |
| Carbonate | | |
| Total “A” | 100 | 63 |

Another example formulation used to produced foams according to the disclosure is shown in Table 2.

TABLE 2

| Ingredient | Parts | Foam Wt % |
|---|---|---|
| B-Side Formulation | | |
| Difunctional aromatic amine - | 69.4 | 22.9 |
| m-Xylenediamine | | |
| Trifunctional aliphatic amine - | 21.1 | 6.9 |
| Tris(2-aminoethyl)amine | | |
| Potassium Hydroxide | 5.8 | 1.9 |
| Water | 3.7 | 1.2 |
| Total “B” | 100 | 32.9 |
| A-Side Formulation | | |
| Trifunctional Epoxy - | 41 | 27.5 |
| Trimethylolpropane triglycidyl | | |
| ether | | |
| Trimethylolpropane triglycidyl | 59 | 39.6 |
| ether-based cyclic carbonate | | |
| Total “A” | 100 | 67.1 |

Another example formulation used to produced foams according to the disclosure is shown in Table 3.

TABLE 3

| Ingredient | Parts | Foam Wt % |
|---|---|---|
| B-Side Formulation | | |
| Pentaerythritol tetrakis(3- | 92.7 | 39.4 |
| mercaptopropionate) | | |
| Diethylenetriamine | 4.9 | 2.1 |
| 1,8-Diazabicyclo[5.4.0]undec-7- | 2.4 | 1.0 |
| ene | | |
| Total “B” | 100 | 42.5 |
| A-Side Formulation | | |
| Olin DER 331 | 13.0 | 7.5 |
| Trimethylolpropane triglycidyl | 87 | 50 |
| ether based-cyclic carbonate | | |
| Total “A” | 100 | 57.5 |

### Example Wall Systems or Insulated Structures

Wall structures or systems of commercial and residential structures are commonly insulated by filling a wall cavity that is positioned between wall studs (wood or metal). The wall cavity may be filled using a spray foam insulation, batt or roll insulation (e.g., fiberglass, mineral wool, cotton, and the like), loose fill insulation (e.g., fiberglass, cellulose, mineral wool, and the like), or a combination thereof. Thermal bridging from the wall studs can reduce the effectiveness of the cavity insulation. To reduce the effects of thermal bridging, the wall system or structure may include external sheathing insulation (e.g., continuous external sheathing), such as with a foil faced rigid polyisocyanurate foam board, that is coupled with the cavity insulation.

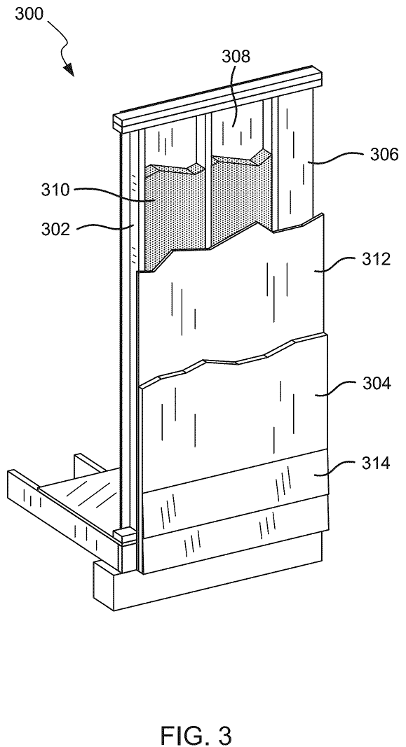

Referring now to FIG. 3, illustrated is an embodiment of a wall system or structure 300 that may be used to insulate a commercial or residential structure. Wall system 300 includes a plurality of structural support members or wall studs 302 that are coupled together to form a wall frame. A plurality of foam boards 304 (hereinafter sheathing boards 304) are attached to an exterior side of the frame to form an insulative exterior wall or surface of the wall system 300 (i.e., continuous external sheathing insulation). A plurality of wall boards 306 are attached to an interior side of the frame opposite the sheathing boards 304 to form an interior wall or surface of the wall system 300. Example wall boards 306 include gypsum boards and the like. The wall studs 302, sheathing boards 304, and wall boards 306 define a plurality of wall cavities 308.

Fasteners (not shown) are used to attach the sheathing boards 304 and wall boards 306 to the respective sides of the frame. Each fastener may include an elongate shaft that penetrates through a respective board and into a wall stud 302 to couple the components together. Example fasteners include nails and screws, although in some embodiments non-mechanical fasteners may be used, such as adhesives and the like. An insulation material 310 is positioned within at least one of the wall cavities 308 of the wall system, and more commonly within each wall cavity 308 or within most of the wall cavities. The insulation material 310 is positioned within the wall cavity 308 to insulate the building or structure. Example insulation materials may include a foam board formed from one or more of the foams discussed herein or one or more spray foams as known in the art.

In some embodiments, an additional wall board 312 may be attached to the exterior side of the frame. In some embodiments, the additional wall board 312 may be free of a halogenated fire retardant, or may include a halogenated fire retardant, where a fire retardant may be present in reduced levels as discussed above, maintaining fire properties at lower foam values. The additional wall board 312 may be a gypsum board, cement board, oriented strand board (OSB), plywood, and the like. Wall board 312 may be positioned between the sheathing board 304 and frame or wall studs 302 for structural support and/or other purposes. External veneer or cladding 314 (hereinafter exterior cladding 314) may be positioned on an exterior side of the sheathing boards 304. In some embodiments, the exterior cladding 314 may be free of a halogenated fire retardant. The exterior cladding 314 may include brick, stucco, rock, siding, paneling, and the like that provides the structure with an aesthetic appeal while optionally also providing one or more desired mechanical or other characteristics. In some embodiments, a drainage cavity or barrier may be positioned between one or more of the components of the wall system, such as between the exterior cladding 314 and the sheathing boards 304. The wall system 600 may also include other components, layers, and/or materials that are not shown, such as an interior vapor barrier, flashing, primer, and the like.

As described herein, the sheathing board 304 of wall system 300 include a poly(hydroxy urethane) core that is produced according to the present technology. The poly(hydroxy urethane) core may be any core described herein.

In some embodiments, the sheathing board 304 may also include a foil facer that is attached to an exterior side of the board. The sheathing boards 304 may have a foam core density of between about 1.0 and 2.5 lbs/ft³, and more commonly between about 1.5 and 2.0 lbs/ft³. In some embodiments, the polyisocyanurate core also include between 1 and 10 weight percent of a hydrocarbon blowing agent. The sheathing board more commonly include between about 5 and 8 weight percent of the hydrocarbon blowing agent. The sheathing board may be any foam board described herein.

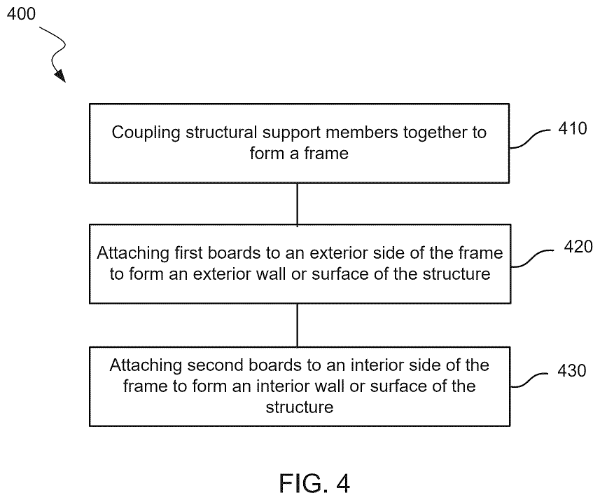

Referring now to FIG. 4, illustrated is a method of forming a wall of a structure. At block 410, a plurality of structural support members (i.e., wall studs) are coupled together to form a frame. At block 420, a plurality of first boards (i.e., foam boards or polyisocyanurate sheathing boards) are attached to an exterior side of the frame to form an insulative exterior wall or surface. At block 430, a plurality of second boards (i.e., wall boards) are attached to an interior side of the frame to form an interior wall or surface. The structural support members, foam boards, and wall boards are coupled together to define a plurality of wall cavities. An insulation material (e.g., a spray foam material, a fiberglass material, or a combination thereof) may be positioned within at least one of the wall cavities, and commonly most or all wall cavities, to insulate an interior space of the structure.

As described herein, at least one of the foam boards includes a poly(hydroxy urethane) core formed according to the present technology.

Wall systems may include those described in U.S. application Ser. No. 14/299,571, now U.S. Pat. No. 9,523,195, which is incorporated herein by reference for all purposes.

### Example Roofing Systems

Commercial and industrial roofing system usually include a combination of layers, such as an insulation layer and a waterproof layer. In some instances, a cover board can be used between the insulation layer and waterproof layer to add fire and/or mechanical protection, such as hail resistance. According to the embodiments herein, a roofing system's insulation layer for commercial and/or industrial roofing includes poly(hydroxy urethane) foam boards. The waterproof layer includes a built-up roof, modified bitumen, and/or a single ply membrane, such as thermoplastic olefin (TPO), polyvinyl chloride (PVC), ethylene propylene diene monomer (EPDM), metal, and the like.

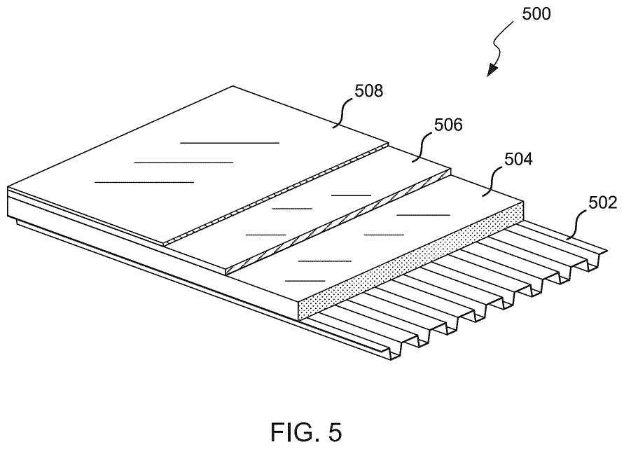

Referring now to FIG. 5, a construction of a commercial roof deck (i.e., roof system 500) is shown. Roof system 500 includes a structural deck 502, which is commonly made of steel or galvanized metal (18 to 22 gauge), although other types of materials and/or sizes are possible. The structural deck 502 is commonly positioned above steel, metal, or other joists and supported thereby. A plurality of foam insulation boards 504 (hereinafter insulation boards 504) are positioned atop the structural deck 502 to form an insulative layer of roofing system 500. As described herein, the insulation boards 504 include one or more poly(hydroxy urethane) foam boards as discussed herein.

In some embodiments, a plurality of cover boards 506 are positioned atop the insulation boards 504 to add a protective layer to roofing system 500. The cover boards 506 may be added for fire and/or mechanical protection (e.g., hail or impact resistance) or for various other reasons. In embodiments, the cover boards 506 may include perlite based boards, gypsum based boards, and the like. In some embodiments, the roofing system 500 does not include cover boards 506. In some embodiments, the cover boards may be boards embodying the present technology.

A waterproof membrane 508 is positioned atop the roofing system 500. The waterproof membrane 508 may be positioned atop the cover boards 506, insulation boards 504, and/or another component/layer of the roofing system 500. In some embodiments, the waterproof membrane 508 may include a built-up roof, modified bitumen, thermoplastic olefin (TPO), ethylene propylene diene monomer (EPDM), metal, and the like. The waterproof membrane 508 may be ballasted, adhered, mechanically fastened, and the like atop the roofing system 500 to couple the waterproof membrane 508 with the roofing system's components/layers. Further, individual components of the waterproof membrane 508 may be coupled together to form the waterproof membrane 508. For example, individual TPO segments, sheets, or strips may be heat welded together to form a substantially continuous TPO layer atop the roofing system 500. Similarly, individual EPDM segments may be adhered or bonded together and metal segments may be mechanically fastened or bonded to form a substantially continuous waterproof membrane layer.

The roofing system 500 may be slightly sloped to promote drainage of water and/or for various other reasons as desired. The roof system 500 may also include other components, layers, and/or materials that are not shown, such as bonding cement, primer, acoustic infills, and the like.

As described herein, the insulation boards 504 and/or cover boards 506 are poly(hydroxy urethane) foam boards that include a poly(hydroxy urethane) core according to one or more of the embodiments discussed herein.

In some embodiments, each of the insulation boards 504 also includes a facer that is coupled with one or more surfaces of the insulation board 504, commonly both surfaces. The facer typically includes a glass fiber mat, but may include other types of facer materials. The facer may include: a reinforced cellulosic felt facer, an un-coated polymer bonded glass fiber mat, a coated polymer bonded glass fiber mat, and the like. The facer may be coated or uncoated as desired to provide a desired characteristic, such as fire retardancy, mechanical strength, and the like.

In some embodiments, each of the cover boards 506 also includes a facer that is coupled with one or more surfaces of the cover board 506, commonly both surfaces. The facer typically includes a glass fiber mat, but may include other types of facer materials.

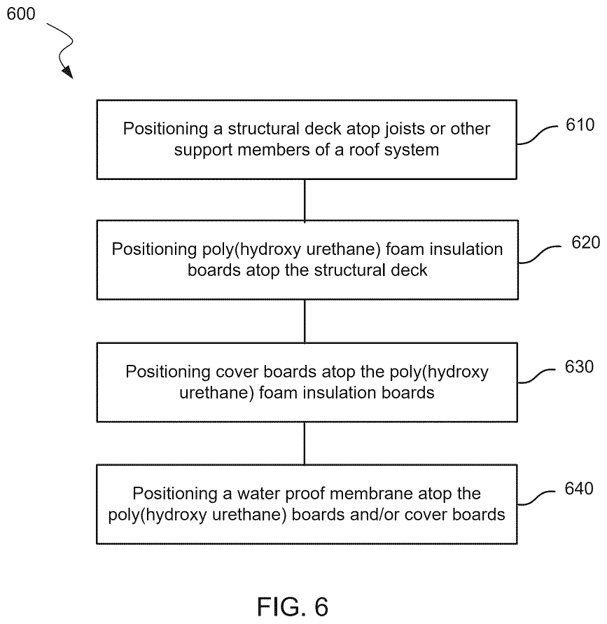

Referring now to FIG. 6, illustrated is a method 600 of forming a roofing system of a structure. At block 610, a structural deck is assembled atop joists (metal and the like) or other structurally supporting members. At block 620, a plurality of foam insulation boards (i.e., poly(hydroxy urethane) foam roof insulation boards) are positioned atop the structural deck to provide an insulation layer for the roofing system. At block 630, a plurality of cover boards are optionally positioned atop the foam insulation boards to form a protective layer for the roofing system. At block 640, a waterproof membrane is positioned atop the foam insulation boards and/or cover boards to provide a waterproof layer for the roofing system.

As described herein, at least one of the foam insulation boards includes a poly(hydroxy urethane) core that is produced according to one or more of the embodiments discussed herein.

Roofing systems may include those described in U.S. application Ser. No. 14/299,631, now U.S. Pat. No. 9,528,269, which is incorporated herein by reference for all purposes.

All patents, patent publications, patent applications, journal articles, books, technical references, and the like discussed in the instant disclosure are incorporated herein by reference in their entirety for all purposes.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A roofing or wall system, comprising:
an insulation product, the insulation product comprising:
a poly(hydroxy urethane) foam formed from components comprising:
a cyclic carbonate monomer, wherein the cyclic carbonate monomer comprises two or more cyclic carbonate groups and a substituted or unsubstituted hydrocarbon backbone containing one or more cyclic groups, and
a multifunctional amine; and
one or more facers affixed to the insulation product;
wherein any reactants used to make the insulation product are free of isocyanate groups.

2. The system of claim 1, wherein the insulation product comprises a poly(hydroxy urethane) foam board.

3. The system of claim 2, wherein the poly(hydroxy urethane) foam board comprises a poly(hydroxy urethane) insulation board.

4. The system of claim 2, wherein the poly(hydroxy urethane) foam board comprises a roof board or a cover board.

5. The system of claim 2, wherein the poly(hydroxy urethane) foam board comprises a sheathing/wall board.

6. The system of claim 1, wherein the insulation product has an R-value per inch of at least 5.7 when measured at 75° F.

7. The system of claim 1, wherein the substituted or unsubstituted hydrocarbon backbone comprises two or more cyclic groups, wherein the two or more cyclic groups comprise substituted or unsubstituted aromatic groups.

8. The system of claim 1, wherein the poly(hydroxy urethane) foam has a decomposition temperature (Td) of greater than or about 300° C.

9. The system of claim 1, wherein the poly(hydroxy urethane) foam has a density of greater than or about 0.4 pounds/ft³.

10. The system of claim 1, wherein the poly(hydroxy urethane) foam has a compressive strength of greater than or about 15 psi.

11. The system of claim 1, wherein the poly(hydroxy urethane) foam is formed using a blowing agent.

12. The system of claim 1, wherein the components used to produce the poly(hydroxy urethane) foam further comprise a multifunctional thiol.

13. The system of claim 1, wherein the components used to produce the poly(hydroxy urethane) form further comprise exothermic reactants used to carry out an exothermic reaction for accelerating the formation of the poly(hydroxy urethane) polymer.

14. The system of claim 13, wherein the exothermic reaction utilizes a poly(epoxy)-poly(amine) reaction, a poly(epoxy)-poly(thiol) reaction, a Michael addition reaction (using known reactants), a poly(acrylate)-poly(amine) reaction (via Aza-Michael addition), a thiolene reaction (via UV or Thia-Michael addition), a UV-catalyzed acrylic reaction, or a poly(anhydride)-poly(amine) reaction, or any combination thereof.

15. The system of claim 13, wherein a physical blowing agent, a chemical blowing agent, or a combination thereof is used to produce the poly(hydroxy urethane) foam.

16. The system of claim 15, wherein the exothermic reaction helps blow off the physical blowing agent, the chemical blowing agent, or the combination thereof.

17. The system of claim 13, wherein the poly(hydroxy urethane) foam comprises the reaction products of the exothermic reaction.

18. The system of claim 1, wherein the facer comprises coated/uncoated fiberglass mat, felt, foil, paper, or any combinations thereof.

19. The system of claim 1, wherein the insulation product further comprises a surfactant.

20. The system of claim 19, wherein the surfactant comprises Niax Silicone L6900, Tegostab B84506, Vorasurf™, DC 193, or any combination thereof.

21. The system of claim 1, wherein the insulation product further comprises a halogenated flame retardant, a non-halogenated flame retardant, or a combination thereof.

22. The system of claim 21, wherein the halogenated fire retardant comprises tris(2-chloroisopropyl)phosphate (TCPP) and the non-halogenated fire retardant comprises diethyl hydroxylmethyl phosphonate (DEHMP), butyl diphenyl phosphate, dibutyl phenyl phosphate, triphenyl phosphate, diethyl N,N-bis(2-hydroxyethyl)aminomethylphosphonate (DEHAMP), dialkyl hydroxyalkanephosphonate (e.g., dimethyl hydroxymethylphosphonate), diaryl hydroxyalkanephosphonate (e.g., diphenyl hydroxymethylphosphonate), or any combination thereof.

23. A method of forming a poly(hydroxy urethane) foam wall or roof insulation product, comprising:
providing a cyclic carbonate monomer, wherein the cyclic carbonate monomer comprises two or more cyclic carbonate groups and a substituted or unsubstituted hydrocarbon backbone containing one or more cyclic groups;
introducing a multifunctional amine and a blowing agent; and
forming a poly(hydroxy urethane) foam;
wherein the reactants used to make the poly(hydroxy urethane) foam insulation product are free of isocyanate groups.

24. The method of claim 23, wherein providing a cyclic carbonate monomer comprises carbonating one or more epoxides with a hydrocarbon backbone containing one or more cyclic groups.

25. The method of claim 24, wherein the carbonating comprises a catalyst and a temperature of greater than or about 60° C.

26. The method of claim 23, wherein the forming a poly(hydroxy urethane) foam step comprises combining the cyclic carbonate monomer, multifunctional primary amine, and blowing agent with at least one catalyst.

27. The method of claim 23, wherein the substituted or unsubstituted hydrocarbon backbone comprises two or more cyclic groups, wherein the two or more cyclic groups comprise substituted or unsubstituted aromatic groups.

28. The method of claim 23, wherein forming poly(hydroxy urethane) foam comprises carrying out an exothermic reaction to accelerate polymerization of the poly(hydroxy urethane) polymer.

29. The method of claim 28, wherein the exothermic reaction comprises a poly(epoxy)-poly(amine) reaction, a poly(epoxy)-poly(thiol) reaction, a Michael addition reaction (using known reactants), a poly(acrylate)-poly(amine) reaction (via Aza-Michael addition), a thiolene reaction (via UV or Thia-Michael addition), a UV-catalyzed acrylic reaction, or a poly(anhydride)-poly(amine) reaction, or any combination thereof.

30. The method of claim 28, wherein forming poly(hydroxy urethane) foam comprises using an physical blowing agent to produce the foam.

31. The method of claim 30, wherein the physical blowing agent comprises a hydrocarbon, a fluorocarbon, or any combination thereof.

32. The method of claim 30, wherein the physical blowing agent comprises cyclopentane, isopentane, n-pentane, or any mixture thereof.

33. The method of claim 30, wherein the physical blowing agent comprises HFC-245fa, HFC-365mfc, HFC-134a, HCFO 1233zd (Solstice® LBA by Honeywell Corp), Forane® 1233zd, HFO-1336mzz (Chemours Opteon™ 1100), or any combination thereof.

34. The method of claim 23, wherein the blowing agent comprises a chemical blowing agent.

35. The method of claim 34, wherein the chemical blowing agent comprises a thiol, water, or a combination thereof.

36. The method of claim 23, wherein the introducing step further comprises introducing a surfactant.

37. The method of claim 23, wherein the introducing step further comprises introducing a halogenated flame retardant, a non-halogenated flame retardant, or a combination thereof.

38. A poly(hydroxy urethane) foam wall or roofing insulation product, comprising:
a poly(hydroxy urethane) polymer produced from components comprising:
a cyclic carbonate monomer, wherein the cyclic carbonate monomer comprises two or more cyclic carbonate groups and a substituted or unsubstituted hydrocarbon backbone containing one or more cyclic groups;
a multifunctional amine;
one or more exothermic reactants; and
a blowing agent comprising:
a multifunctional thiol,
a hydrocarbon,
a fluorocarbon,
or any combination thereof;
wherein any components used to produce poly(hydroxy urethane) foam insulation product are free of isocyanate groups.
